(19) United States
(12) Patent Application Publication
(10) Pub. No.: US 2018/0005784 A1
(43) Pub. Date: Jan. 4, 2018

(54) VACUUM CIRCUIT BREAKER

(71) Applicant: MEIDENSHA CORPORATION, Tokyo (JP)

(72) Inventors: Kazuhiro NAGATAKE, Numazu-shi, Shizuoka (JP); Akihiro SUWA, Numazu-shi, Shizuoka (JP)

(73) Assignee: MEIDENSHA CORPORATION, Tokyo (JP)

(21) Appl. No.: 15/540,433

(22) PCT Filed: Dec. 25, 2015
(86) PCT No.: PCT/JP2015/086157

§ 371 Date: Jun. 28, 2017

(30) Foreign Application Priority Data
Jan. 7, 2015 (JP) 2015-001239

(51) Int. Cl. H01H 33/662; H01H 33/666

(52) U.S. Cl. CPC H01H 33/66238; H01H 33/666

(57) ABSTRACT

A vacuum circuit breaker includes a ground tank, first and second vacuum interrupters, a link mechanism for opening and closing the vacuum interrupters and a link mechanism case housing the link mechanism and supported by an insulating support tube. An insulating operation rod for operating the link mechanism is provided through the insulating support tube and a side portion of the ground tank. An operation room is provided around the portion of the ground tank through which the insulating operation rod is inserted. A conversion mechanism for driving the insulating operation rod is arranged in the operation room. A space communicating with inner sides of bellows of the vacuum interrupters (including the inside of the link mechanism case and the inside of the insulating support tube) is filled with insulating gas of 0.3 MPa or lower. The other space is filled with insulating gas of higher pressure.

### FIELD OF THE INVENTION

The present invention relates to a vacuum circuit breaker and, more particularly, to an internal pressure structure of a double-break vacuum circuit breaker.

### BACKGROUND ART

Vacuum circuit breakers (VCB) are widely used for power systems, notably medium-voltage class power systems of 84 kV or lower. The vacuum circuit breaker is advantageous to other circuit breakers (such as gas circuit breaker (GCB)) in that: a breaker part of the vacuum circuit breaker is long in lifetime; the amount of high-global-warming-potential gas (e.g. SF₆ gas) used in the vacuum circuit breaker is small; and the vacuum circuit breaker is low in life cycle cost (LCC) because of easy recovery and recycling of SF₆ gas. The vacuum circuit breaker of tank type, which has a vacuum interrupter (VI) covered by a ground layer, is low in gravity center and is advantageous to conventional insulator type breakers in that: it is easier to mount a current transformer to the tank type vacuum circuit breaker; and the tank type vacuum circuit breaker is improved in earthquake resistance.

Various proposals have recently been made to obtain high-voltage high-capacity vacuum circuit breakers for expanded uses of the vacuum circuit breakers (see, for example, Non-Patent Document 1). In one proposed high-voltage vacuum circuit breaker, two vacuum interrupters as breaker parts are connected in series so as to improve withstand voltage performance.

FIG. 4 is a vertical sectional front view of a vacuum circuit breaker 35 according to such conventional technology. This vacuum circuit breaker 35 includes a ground tank 2, vacuum interrupters 3 and 4 accommodated in the ground tank 2, and a link mechanism 5 for opening and closing the vacuum interrupters 3 and 4.

The ground tank 2 is in the form of a cylindrical metallic container in which the vacuum interrupters 3 and 4 and the link mechanism 5 are accommodated. The inside of the ground tank 2 is filled with insulating gas such as SF₆ gas.

In the vacuum interrupter 3, a pair of electrodes (a fixed electrode 7 and a movable electrode 8) are placed in a vacuum vessel 6 which is constituted by an insulating tube and a metallic flange. An intermediate shield 9 is disposed within the vacuum vessel 6 so as to cover the fixed electrode 7 and the movable electrode 8. The fixed electrode 7 is fixed to one end portion of a fixed lead 3a. The other end portion of the fixed lead 3a protrudes from an end face of the vacuum vessel 6 and is fixed to a support insulating member 10. A conductor 12 is coupled to the other end portion of the fixed lead 3a via a metallic conductor fitting 11. The movable electrode 8 is fixed to one end portion of a movable lead 3b. The other end portion of the movable lead 3b protrudes from an end face of the vacuum vessel 6 and is coupled to the link mechanism 5. A bellows 13 is disposed on a part of the movable lead 3d inserted within the vacuum vessel 6 so as to allow axial movement of the movable lead 3b while maintaining the vacuum inside the vacuum vessel 6. A voltage-dividing capacitor 14 is arranged in parallel with the vacuum interrupter 3.

The vacuum interrupter 4 is similar in configuration to the vacuum interrupter 3. In the vacuum interrupter 4, a pair of electrodes (a fixed electrode 7 and a movable electrode 8) are placed in a vacuum vessel 6. The fixed electrode 7 is fixed to one end portion of a fixed lead 4a. The other end portion of the fixed lead 4a is fixed to a support insulating member 15. A conductor 17 is coupled to the other end portion of the fixed lead 4a via a metallic conductor fitting 16. The movable electrode 8 is fixed to one end portion of a movable lead 4b. The other end portion of the movable lead 4b protrudes from an end face of the vacuum vessel 6 and is coupled to the link mechanism 5. A voltage-dividing capacitor 18 is arranged in parallel with the vacuum interrupter 4.

The link mechanism 5 is provided with a link member 5a, a link member 5b and link members 5c, and is placed in a link mechanism case 36. One end portion of the link member 5a is rotatably supported in the link mechanism case 36; and the other end portion of the link member 5a is rotatably supported on the movable lead 3b. One end portion of the link member 5c is rotatably disposed on the link member 5a; and the other end portion of the link member 5c is rotatably supported on one end portion of an insulating operation rod 20, which is used for opening/closing operations of the vacuum interrupters 3 and 4. Similarly, one end portion of the link member 5b is rotatably supported in the link mechanism case 36; and the other end portion of the link member 5b is rotatably supported on the movable lead 4b. One end portion of the link member 5c is rotatably supported on the link member 5b; and the other end portion of the link member 5c is rotatably supported on the one end portion of the insulating operation rod 20.

The link mechanism case 36 is shaped to house therein the link mechanism 5 and to provide electrical connection between the movable lead 3b and the movable lead 4b. The link mechanism case 36 is arranged between a movable-side end portion of the vacuum interrupter 3 (from which the movable lead 3b protrudes) and a movable-side end portion of the vacuum interrupter 4 (from which the movable lead 4b protrudes). The link mechanism case 36 is supported by an insulating support tube 21 which is disposed on an inner circumferential surface of the ground tank 2.

The insulating operation rod 20 is inserted and passes through the link mechanism case 36, the insulating support tube 21 and a side portion of the ground tank 2. Further, an operation room 23 is provided on an outer circumference of the portion of the ground tank 2 through which the insulating operation rod 20 is inserted.

A conversion mechanism 24 for converting rotation of a rotation shaft 25 to linear movement of the insulating operation rod 20 is arranged in the operation room 23. One end portion of the rotation shaft 25 is exposed outside from the operation room 23 through a rotational seal 26. An operation mechanism (not shown) for operating the insulating operation rod 20 and a drive unit for driving an insulating operation rod of another phase are coupled to the rotation shaft 25 at positions outside the operation room 23.

In the vacuum circuit breaker 35, the insides of the ground tank 2, the link mechanism case 36, the insulating support tube 21 and the operation room 23 are filled with insulating gas so as to insulate the high-voltage parts such as the conductors 12 and 17, the fixed- and movable-side end portions of the vacuum interrupters 3 and 4 and the link mechanism case 36 from the ground tank 2 of ground potential. For example, SF₆ gas of about 0.25 MPa is used as the insulating gas. The SF₆ gas has good insulation properties and can perform its function at a low pressure. The vacuum circuit breaker 35 has a double-break structure in which the vacuum interrupters 3 and 4 as breaker parts are connected in series and thus shows a high withstand voltage for use in high voltage applications.

In the above structure, input operation is executed when the insulating operation rod 20 is moved in a direction toward the inside of the ground tank 2 (i.e. an upward direction in the figure) by rotation of an unillustrated lever, which is coupled to a drive unit 27, in response to an input command. As the insulating operation rod 20 is moved, the link 5c coupled to the link 5a moves upward while turning right. With this movement of the link 5c, the link 5a moves the movable lead 3b along the axis in a direction toward the vacuum interrupter 3. The fixed electrode 7 and the movable electrode 8 of the vacuum interrupter 3 are consequently connected to each other. Similarly, the link 5c coupled to the link 5b moves upward while turning left as the insulating operation rod 20 is moved. With this movement of the link 5c, the link 5b moves the movable lead 4b along the axis in a direction toward the vacuum interrupter 4. The fixed electrode 7 and the movable electrode 8 of the vacuum interrupter 4 are consequently connected to each other.

Further, breaking operation is executed when the insulating operation rod 20 is moved in a direction toward the outside of the ground tank 2 (i.e. a downward direction in the figure). By the reverse action to that in the input operation, the movable lead 3b moves along the axis in a direction apart from the vacuum interrupter 3 so that the fixed electrode 7 and the movable electrode 8 of the vacuum interrupter 3 are separated from each other. The movable lead 4b also moves along the axis in a direction apart from the vacuum interrupter 4 so that the fixed electrode 7 and the movable electrode 8 of the vacuum interrupter 4 are separated from each other.

In the vacuum interrupters 3 and 4, the vacuum in the vacuum vessel 6 is maintained by the expandable and contractible bellows 13 even when the movable lead 3b, 4b moves during the input and breaking operations. The bellows 13 is thus structured to bear a pressure difference to some extent between the vacuum on the outer side and the pressure of the insulating gas on the inner side.

However, the bellows 13 is made of a thin metal material of e.g. stainless steel and suffers a phenomenon called buckling when the pressure difference becomes larger than or equal to a certain level. For this reason, the pressure of the insulating gas on the inner side of the bellows needs to be lower than or equal to about 0.3 MPa.

Namely, although it is conceivable to increase the pressure of the insulating gas filled in the vacuum circuit breaker and thereby improve the insulation performance of the vacuum circuit breaker for use in higher voltage applications, the bellows becomes one of the weakest points in the vacuum interrupter due to such a gas pressure increase.

It has thus been studied to provide the bellows with a structure capable of bearing a pressure difference between the inner and outer sides thereof (e.g. external pressure type bellows) (see, for example, Non-Patent Document 2). The material and structure of the bellows used in the high pressure resistant vacuum interrupter are however special and can become a cause of cost increase of the vacuum circuit breaker. Further, the use of the external pressure type bellows can lead to an upsizing of the bellows part and a deterioration of the heat dissipation performance of the vacuum interrupter.

As to a single-break tank-type vacuum circuit breaker, it has been proposed to fill the insulating support tube, which is not in communication with the inner side of the bellows, with high pressure dry air and set the inner side of the bellows to an atmospheric pressure for the purpose of preventing bucking of the bellows while preventing global warming (see, for example, Patent Document 1).

### PRIOR ART DOCUMENTS

### Patent Documents

Patent Document 1: Japanese Laid-Open Patent Publication No. 2007-306701

### Non-Patent Documents

Non-Patent Document 1: Kazuhiro NAGATAKE and Four Others, “Development of 168 kV 40 kA 2-point Breaking Type Vacuum Circuit Breaker”, Proceedings of Heisei 17 Annual Conference of Power and Energy Society, Institute of Electrical Engineering of Japan, 2005, No. 319, pp. 38-3, 38-4

Non-Patent Document 2: Kazuhiro NAGATAKE and Five Others, “Development of Environmentally Benign Type 72/84 kV Vacuum Circuit Breaker”, Proceedings of Heisei 15 Annual Conference of Power and Energy Society, Institute of Electrical Engineering of Japan, 2003, No. 237, pp. B-143, B-144

### SUMMARY OF THE INVENTION

It is an object of the present invention to provide a technique for contributing to high voltage applications of a double-break vacuum circuit breaker.

To achieve the above object, there is provided according to the present invention a vacuum circuit breaker, comprising: first and second vacuum interrupters each having: a vacuum vessel with an insulating tube and a metallic flange; fixed and movable electrodes placed in the vacuum vessel; a movable lead supporting the movable electrode such that the movable electrode can be brought into contact with or separated from the fixed electrode; and a bellows disposed on a part of the movable lead inserted within the vacuum vessel; a ground tank that accommodates the first vacuum interrupter and the second vacuum interrupter; a link mechanism arranged in the ground tank so as to move the movable lead of the first vacuum interrupter and the movable lead of the second vacuum interrupter in an axial direction; a link mechanism case that houses the link mechanism; an insulating support tube disposed on an inner circumferential surface of the ground tank and supporting the link mechanism case; and an insulating operation rod coupled to the link mechanism so as to cause operation of the link mechanism, wherein the movable lead of the first vacuum interrupter is inserted in the link mechanism case so as to allow communication between an inside of the link mechanism case and an inner side of the bellows of the first vacuum interrupter through a portion of the link case mechanism in which the movable lead of the first vacuum interrupter is inserted; wherein the movable lead of the second vacuum interrupter is inserted in the link mechanism case so as to allow communication between the inside of the link mechanism case and an inner side of the bellows of the second vacuum interrupter through a portion of the link case mechanism in which the movable lead of the second vacuum interrupter is inserted; wherein the insulating operation rod is inserted through an inside of the insulating support tube and through a side portion of the ground tank; wherein the inner side of the bellows of the first vacuum interrupter, the inner side of the bellows of the second vacuum interrupter, the inside of the link mechanism case and the inside of the insulating support tube communicate with one another to define a communication space; wherein the communication space is hermetically isolated from a space inside the ground tank and outside the link mechanism case and the insulating support tube; wherein the space communicating with the inner side of the bellows of the first vacuum interrupter and the inner side of the bellows of the second vacuum interrupter is filled with insulating gas of 0.3 MPa or lower; and wherein the space inside the ground tank and outside the link mechanism case and the insulating support tube is filled with insulating gas of higher pressure than that of the insulating gas in the space communicating with the inner side of the bellows of the first vacuum interrupter and the inner side of the bellows of the second vacuum interrupter.

### BRIEF DESCRIPTION OF THE DRAWINGS

FIG. 1 is a sectional view of a vacuum circuit breaker according to one embodiment of the present invention.

FIG. 2 is an enlarged sectional view of a principal part of the vacuum circuit breaker according to the one embodiment of the present invention.

FIG. 3 is an enlarged sectional view of a principal part of a vacuum circuit breaker according to another embodiment of the present invention.

FIG. 4 is a sectional view of a vacuum circuit breaker according to the conventional technology.

### DESCRIPTION OF THE EMBODIMENTS

A vacuum circuit breaker according to one embodiment of the present invention will be described below with reference to the drawings. It should be understood that: the drawings are intended to schematically show the vacuum circuit breaker according to one embodiment of the present invention; and the dimensions of the respective parts and portions in the drawings may be exaggerated for illustration purposes.

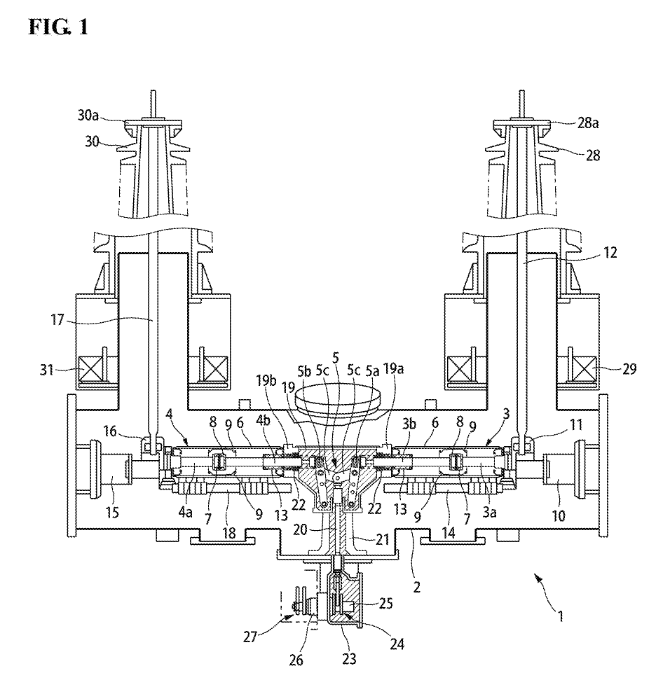

FIG. 1 is a vertical sectional front view of a vacuum circuit breaker 1 according to one embodiment of the present invention. The vacuum circuit breaker 1 includes a ground tank 2, vacuum interrupters 3 and 4 accommodated in the ground tank 2, and a link mechanism 5 for opening and closing the vacuum interrupters 3 and 4.

The ground tank 2 is in the form of a cylindrical metallic container in which the vacuum interrupters 3 and 4 and the link mechanism 5 are accommodated. The inside of the ground tank 2 is filled with insulating gas such as SF₆ gas.

In the vacuum interrupter 3, a pair of electrodes (a fixed electrode 7 and a movable electrode 8) are placed in a vacuum vessel 6 which is constituted by an insulating tube and a metallic flange. An intermediate shield 9 is disposed within the vacuum vessel 6 so as to cover the fixed electrode 7 and the movable electrode 8. The fixed electrode 7 is fixed to one end portion of a fixed lead 3a. The other end portion of the fixed lead 3a protrudes from an end face of the vacuum vessel 6 and is fixed to a support insulating member 10. A conductor 12 is coupled to the other end portion of the fixed lead 3a via a metallic conductor fitting 11. The movable electrode 8 is fixed to one end portion of a movable lead 3b. The other end portion of the movable lead 3b protrudes from an end face of the vacuum vessel 6 and is coupled to the link mechanism 5. A bellows 13 is disposed on a part of the movable lead 3d inserted within the vacuum vessel 6 so as to allow axial movement of the movable lead 3b while maintaining the vacuum inside the vacuum vessel 6. A voltage-dividing capacitor 14 is arranged in parallel with the vacuum interrupter 3.

The vacuum interrupter 4 is similar in configuration to the vacuum interrupter 3. In the vacuum interrupter 4, a pair of electrodes (a fixed electrode 7 and a movable electrode 8) are placed in a vacuum vessel 6. The fixed electrode 7 is fixed to one end portion of a fixed lead 4a. The other end portion of the fixed lead 4a is fixed to a support insulating member 15. A conductor 17 is coupled to the other end portion of the fixed lead 4a via a metallic conductor fitting 16. The movable electrode 8 is fixed to one end portion of a movable lead 4b. The other end portion of the movable lead 4b protrudes from an end face of the vacuum vessel 6 and is coupled to the link mechanism 5. A voltage-dividing capacitor 18 is arranged in parallel with the vacuum interrupter 4.

The link mechanism 5 is provided with a link member 5a, a link member 5b and link members 5c, and is placed in a link mechanism case 19. One end portion of the link member 5a is rotatably supported in the link mechanism case 19; and the other end portion of the link member 5a is rotatably coupled to the movable lead 3b. One end portion of the link member 5c is rotatably disposed on the link member 5a; and the other end portion of the link member 5c is rotatably supported on one end portion of an insulating operation rod 20, which is used for opening/closing operations of the vacuum interrupters 3 and 4. Similarly, one end portion of the link member 5b is rotatably supported in the link mechanism case 19; and the other end portion of the link member 5b is rotatably coupled to the movable lead 4b. One end portion of the link member 5c is rotatably supported on the link member 5b; and the other end portion of the link member 5c is rotatably supported on the one end portion of the insulating operation rod 20.

The link mechanism case 19 is shaped to house therein the link mechanism 5 and to provide electrical connection between the movable lead 3b and the movable lead 4b. The link mechanism case 19 is arranged between a movable-side end portion of the vacuum interrupter 3 (from which the movable lead 3b protrudes) and a movable-side end portion of the vacuum interrupter 4 (from which the movable lead 4b protrudes). The link mechanism case 19 is supported by an insulating support tube 21 which is disposed on an inner circumferential surface of the ground tank 2.

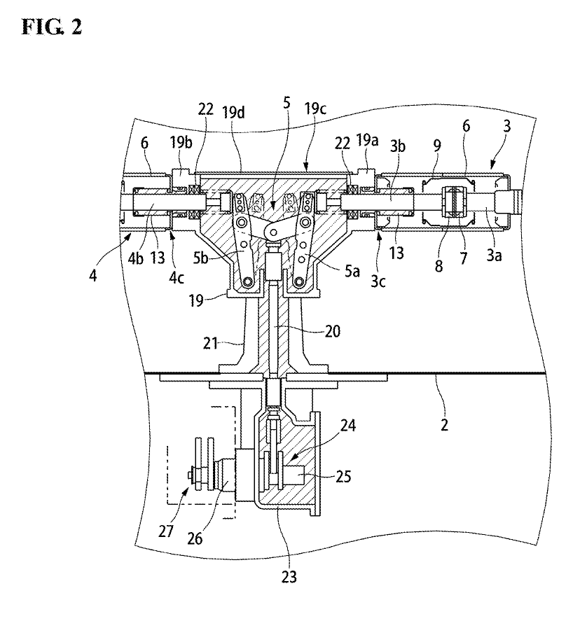

As shown in FIG. 2, the link mechanism case 19 and the movable-side end portion 3c of the vacuum interrupter 3 are hermetically connected to each other by a packing such as O-ring (not shown). The movable lead 3b is inserted in the link mechanism case 19. The inner side of the bellows 13 of the vacuum interrupter 3 is in communication with the inside of the link mechanism case 19 through the portion 19a of the link mechanism case 19 in which the movable lead 3b is inserted. A connection part 22 such as ring contact is provided in the lead insertion portion 19a so as to provide electrical connection between the movable lead 3b and the link mechanism case 19. Similarly, the link mechanism case 19 and the movable-side end portion 4c of the vacuum interrupter 4 are hermetically connected to each other by a packing such as O-ring (not shown). The movable lead 4b is inserted in the link mechanism case 19. The inner side of the bellows 13 of the vacuum interrupter 4 is in communication with the inside of the link mechanism case 19 through the portion 19b of the link mechanism case 19 in which the movable lead 4b is inserted. A connection part 22 such as ring contact is also provided in the lead insertion portion 19b so as to provide electrical connection between the movable lead 4b and the link mechanism case 19. A manhole 19c is formed in an upper portion of the link mechanism case 19 for placement of the link mechanism 5 in the link mechanism case 19. The manhole 19c is sealed with a seal member 19d.

As shown in FIG. 1, the insulating support tube 21 is disposed on the inner circumferential portion of the ground tank 2 so as to support the link mechanism case 19. A connection part between the insulating support tube 21 and the link mechanism case 19 and a connection part between the insulating support tube 21 and the ground tank 2 are hermitically sealed by packings such as O-rings

The insulating operation rod 20 is inserted and passes through the link mechanism case 19, the inside of the insulating support tube 21 and a side portion of the ground tank 2. Further, an operation room 23 is provided on an outer circumferential side of the portion of the ground electrode 2 through which the insulating operation rod 20 is inserted.

The operation room 23 is hermetically sealed to the outer circumferential side of the ground tank 2 by a packing such as O-ring. A conversion mechanism 24 is arranged in the operation room 23 and configured to convert rotation of a rotation shaft (rotation drive shaft) 25 to linear movement of the insulating operation rod 20. One end portion of the rotation shaft 25 is exposed outside from the operation room 23 through a rotational seal 26 (e.g. a rotational seal casing sealed with a hydraulic packing such as SKY packing). An operation mechanism (not shown) for operating the insulating operation rod 20 and a drive unit 27 for driving an insulating operation rod of another phase are coupled to the rotation shaft 25 at positions outside the operation room 23. In the operation room 23, there are also provided a pressure gauge for monitoring the pressure inside the operation room 23, a valve for adjusting the pressure inside the operation room 23 and the like although not shown in the drawings.

The conductor 12 is arranged to protrude from the ground tank 2. A bushing 28 is disposed around the conductor 12 and supported by the ground tank 2. A bushing terminal 28a is provided on an upper end portion of the bushing 28. A bushing current transformer 29 is provided in a connection part between the bushing 28 and the ground tank 2. Similarly, the conductor 17 is arranged to protrude from the ground tank 2. A bushing 30 is disposed around the conductor 17 and supported by the ground tank 2. A bushing terminal 30a is provided on an upper end portion of the bushing 30. A bushing current transformer 31 is provided in a connection part between the bushing 30 and the ground tank 2.

In the above-structured vacuum circuit breaker 1, the inner side of the bellows 13 of the vacuum interrupter 3, the inner side of the bellows 13 of the vacuum interrupter 4, the inside of the link mechanism case 19, the inside of the insulating support tube 21 and the inside of the operation room 23 are in communication with one another to define a sealed communication space. This space is filled with insulating gas of 0.3 MPa or lower (for example, SF₆ gas of 0.25 MPa). The diagonally shaded area in FIG. 1 corresponds to the space filled with such low pressure insulating gas. On the other hand, a space inside the ground tank 2 and the bushings 28 and 30 is filled with high pressure insulating gas (for example, SF₆ gas of higher pressure than that on the inner side of the bellows 13 of the vacuum interrupter 3 and on the inner side of the bellows 13 of the vacuum interrupter 4).

The low-pressure-side space (which is in communication with the inner sides of the bellows 13 of the vacuum interrupters 3 and 4) and the high-pressure-side space (which is isolated from and not in communication with the inner sides of the bellows 13) may be filled with insulating gas other than SF₆ gas, such as dry air, nitrogen gas (N₂) or carbon dioxide gas (CO₂).

For ease of maintenance of the vacuum circuit breaker 1, it is preferable to fill the low-pressure-side space and the high-pressure-side space with the same kind of insulating gas. In the case of filling the low-pressure-side space and the high-pressure-side space with SF₆ gas, for example, the higher the pressure of the SF₆ gas in the high-pressure-side space, the more improved the insulation performance of the vacuum circuit breaker 1. This leads to downsizing of the vacuum circuit breaker 1. In the case of filling the low-pressure-side space and the high-pressure-side space with dry air, the insulation performance tends to be lowered as compared with the case of SF₆ gas. It is however possible to compensate for the lowered insulation performance by increasing the pressure of the dry air filled in the high-pressure-side space. In this case, the lowered insulation performance in the low-pressure-side space can be compensated for by e.g. increasing the distance between the high-voltage part and the ground potential part.

By filling the low-pressure-side space and the high-pressure-side space with different kinds of insulating gases, the vacuum circuit breaker 1 can be obtained so as to comply with prevention of global warming without upsizing of the vacuum circuit breaker 1. In the case of filling the low-pressure-side space with SF₆ gas and filling the high-pressure-side space with dry air, for example, it is possible to suppress the amount of use of the SF₆ gas and suppress upsizing of the vacuum circuit breaker 1.

Next, an explanation will be given of input and breaking operations of the vacuum circuit breaker 1. The input and breaking operations of the vacuum circuit breaker 1 are actuated with operation of the link mechanism 5 by the insulating operation rod 20. Since the rotational seal 26 is provided in the rotation shaft 17 insertion portion of the operation room 23 in the vacuum circuit breaker 1, the input operation (or breaking operation) of the vacuum circuit breaker 1 is executed by operating the insulating operation rod 20 in the state where the pressure inside the operation room 23 (i.e. the pressure on the inner sides of the bellows 13) is maintained at a low pressure of 0.3 MPa.

The input operation of the vacuum circuit breaker 1 is executed by the action of the link mechanism 5 when the insulating operation rod 20 is moved in a direction toward the inside of the ground tank 2 (an upward direction in the figure). As the insulating operation rod 20 is moved, the link 5c coupled to the link 5a moves upward while turning right. With this movement of the link 5c, the link 5a moves the movable lead 3b along the axis in a direction toward the vacuum interrupter 3. The fixed electrode 7 and the movable electrode 8 of the vacuum interrupter 3 are consequently brought into contact with and connected to each other. Similarly, the link 5c coupled to the link 5b moves upward while turning left as the insulating operation rod 20 is moved. With this movement of the link 5c, the link 5b moves the movable lead 4b along the axis in a direction toward the vacuum interrupter 4. The fixed electrode 7 and the movable electrode 8 of the vacuum interrupter 4 are consequently brought into contact with and connected to each other.

The breaking operation is executed by the action of the link mechanism 5 when the insulating operation rod 20 is moved in a direction toward the outside of the ground tank 2 (a downward direction in the figure). By the reverse action to that in the input operation, the movable lead 3b moves along the axis in a direction apart from the vacuum interrupter 3 so that the fixed electrode 7 and the movable electrode 8 of the vacuum interrupter 3 are separated from each other. The movable lead 4b also moves along the axis in a direction apart from the vacuum interrupter 4 so that the fixed electrode 7 and the movable electrode 8 of the vacuum interrupter 4 are separated from each other.

In the vacuum circuit breaker 1 according to the above embodiment of the present invention, it is possible to suppress damage on the bellows 13 by setting the pressure of the insulating gas on the inner sides of the bellows 13 of the vacuum interrupters 3 and 4 to be 0.3 MPa or lower and thereby reducing the pressure difference between the inner and outer sides of the bellows 13. It is further possible to improve the insulation performance of the vacuum circuit breaker 1 for use in high voltage application by increasing the pressure of the insulating gas in the space not communicating with the inner sides of the bellows 13 (e.g. the space inside the ground tank 2 and outside the link mechanism case 19 and the insulating support tube 21). For example, dry air of about 0.6 MPa is usable in the case of the vacuum circuit breaker with high pressure resistant vacuum interrupters. Hence, the pressure of the insulating gas in the space not communicating with the inner sides of the bellows 13 is set higher than the pressure of the insulating gas in the space in communication with the inner sides of the bellows 13, preferably higher than 0.3 MPa, more preferably 0.6 to 0.8 MPa, in order to improve the insulation performance of the vacuum circuit breaker 1 without upsizing of the vacuum circuit breaker 1.

Heretofore, double-break vacuum circuit breakers have been used mainly in the medium voltage class. Not many considerations have been made about high voltage applications of vacuum circuit breakers. By contrast, the above-structured double-break vacuum circuit breaker 1 according to the present invention is improved in insulation performance and suitable for higher voltage applications. It is accordingly possible to expand the range of uses of the vacuum circuit breaker 1 up to the higher voltage class (e.g. 84 kV or higher voltage class). In view of the usage of a vacuum circuit breaker with a single vacuum interrupter as a vacuum circuit breaker of 145 kV voltage class, it is conceivable that the range of uses of the double-break vacuum circuit breaker could be expanded up to 300 kV or higher voltage class.

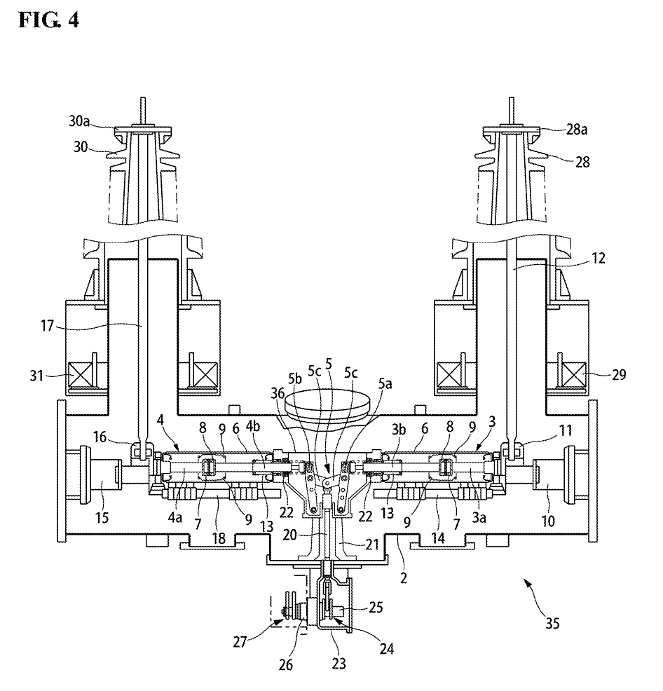

Because of the high global warming potential of the SF₆ gas, it is required to minimize the amount of use of the SF₆ gas for prevention of global warming. Considerations have been made to the use of dry air, which is substantially zero in global warming potential and effective for prevention of global warming, and other insulating gases such as nitrogen gas (N₂), carbon dioxide gas (CO₂) etc. as alternatives to the SF₆ gas. The insulation properties of these alternative gases are inferior to those of the SF₆ gas. Thus, the pressure of the alterative gas filled in the vacuum circuit breaker needs to be increased to about 0.5 to 0.6 MPa for insulation performance improvement. Due to such a gas pressure increase, however, the bellows 13 of the vacuum interrupter 3 (or the bellows 13 of the vacuum interrupter 4) may be damaged. More specifically, in the conventional vacuum circuit breaker 35 of FIG. 4, the introduction of high pressure insulating gas to the inside of the ground tank 2 leads to the introduction of high pressure insulating gas to the space communicating with the inner side of the bellows 13. As a result, there arises a large pressure difference between the vacuum on the outer side of the bellows 13 and the high pressure on the inner side of the bellows 13 so that the bellows 13 may be damaged due to the large pressure difference. In the case of decreasing the pressure of the insulating gas introduced to the ground tank 2 for suppression of damage on the bellows 13, the distance between the high-voltage part and the ground potential part (e.g. between the link mechanism case 26 and the ground tank 2 becomes increased to compensate for the lowered insulation performance. This distance increase causes upsizing of the vacuum circuit breaker 35.

On the other hand, the vacuum circuit breaker 1 according to the above embodiment of the present invention has a structure (so-called double-pressure-chamber structure) in which: the space communicating with the inner sides of the bellows is filled with the low pressure insulating gas; and the other insulation space is filled with the high pressure insulating gas. By the adoption of such a structure, it is possible to suppress damage on the bellows 3 and improve the insulation performance of the vacuum circuit breaker 1. For example, by filling the high-electric-field space such as the space between the link mechanism case 19 and the ground tank 2 with high-pressure dry air, the use of the high-global-warming-potential insulating gas is suppressed, without impairment of the insulation performance, so as to contribute to prevention of global warming

Furthermore, the bellows 13 does not need to be provided with a structure capable of bearing a pressure difference between the inner and outer sides thereof in the vacuum circuit breaker 1 according to the above embodiment of the present invention. A mass-produced type bellows can be utilized for cost reduction of the vacuum interrupter 3, 4. The utilization of such an ordinary internal pressure type bellows allows use of an operation unit having a small self-closing force and small operating force. It is accordingly possible to manufacture the vacuum circuit breaker 1 at a low cost, without using special high pressure resistant vacuum interrupters, and suppress upsizing of the vacuum circuit breaker 1.

The end portion of the rotation shaft 15 of the conversion mechanism 14, which is used for operation of the insulating operation rod 20, is exposed outside the operation room 23 through the rotational seal 26. The rotation shaft 15 is thus operated while maintaining hermeticity. In other words, by arranging one hermetic seal to the insulating operation rod 2, the opening and closing operations of the vacuum interrupters 3 and 4 are executed in the state where the inner sides of the bellows 13 of the vacuum interrupters 3 and 4 are kept hermetically sealed. Since one hermetical sliding part is provided in the vacuum circuit breaker, it is possible to reduce the number of components of the vacuum circuit breaker 1 and improve the reliability of the vacuum circuit breaker 1 as compared to the case of respectively maintaining hermetic seals on the movable parts of the vacuum interrupters 3 and 4.

It should be understood that: the vacuum circuit breaker according to the present invention is not limited to the above-described embodiment; various changes and modification of the embodiment described above can be made within the range that does not impair the features of the present invention; and all such changes and modifications fall within the scope of the present invention.

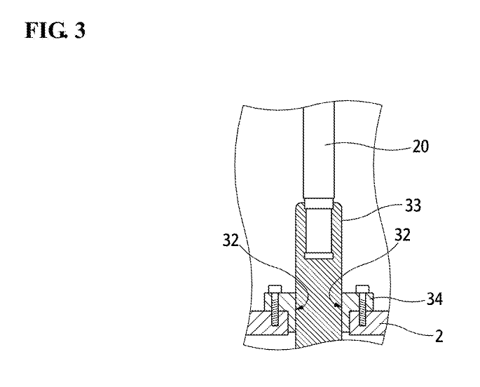

For example, it is feasible to arrange a linear seal 32 in the portion of the ground tank 2 through which the insulating operation rod 20 is inserted as shown in FIG. 3. More specifically, the linear seal 32 is provided by disposing a ground-side fitting 33 on a portion of the insulating operation rod 20 which is inserted through the ground tank 2 disposing a housing 34 in the portion of the ground tank 2 through which the insulating operation rod 20 is inserted. For opening or closing of the vacuum interrupters 3 and 4, the insulating operation rod 20 makes sliding movement in the direction toward the inside or outside of the ground tank 2 while maintaining hermeticity between the outer side of the ground-side fitting 33 and the inner side of the housing 34. The insulating operation rod 20 is thus operated in the state where the inside of the insulating support tube 21 is kept hermetically sealed. By arranging such a linear seal 32 in the portion of the ground tank 2 through which the insulating operation rod 20 is inserted, the space filled with the low pressure insulating gas is further narrowed so that it is possible to obtain a further reduction in the amount of the insulating gas filled in the space communicating with the inner sides of the bellows 13 as well as the effects of the vacuum circuit breaker 1 according to the above embodiment.

Although the above embodiment specifically refers to the vacuum circuit breaker 1 in which the movable lead 3b of the vacuum interrupter 3 and the movable lead 4b of the vacuum interrupter 4 are arranged coaxially with each other, the present invention is also applicable to a vacuum circuit breaker of the type in which the movable lead 3b and the movable lead 4b are arranged at an acute angle to each other or in which the movable lead 3b and the movable lead 4b are arranged in parallel with each other.

1-3. (cancelled)

4. A vacuum circuit breaker, comprising:
first and second vacuum interrupters each having: a vacuum vessel with an insulating tube and a metallic flange; fixed and movable electrodes placed in the vacuum vessel; a movable lead supporting the movable electrode such that the movable electrode can be brought into contact with or separated from the fixed electrode; and a bellows disposed on a part of the movable lead inserted within the vacuum vessel;
a ground tank that accommodates the first vacuum interrupter and the second vacuum interrupter;
a link mechanism arranged in the ground tank so as to move the movable lead of the first vacuum interrupter and the movable lead of the second vacuum interrupter in an axial direction;
a link mechanism case that houses the link mechanism;
an insulating support tube disposed on an inner circumferential surface of the ground tank and supporting the link mechanism case;
an insulating operation rod coupled to the link mechanism so as to cause operation of the link mechanism; and
an operation room provided on an outer side of the portion of the ground tank through which the insulating operation rod is inserted, such that the operation room is in communication with the inside of the insulating support tube,
wherein the movable lead of the first vacuum interrupter is inserted in the link mechanism case so as to allow communication between an inside of the link mechanism case and an inner side of the bellows of the first vacuum interrupter through a portion of the link case mechanism in which the movable lead of the first vacuum interrupter is inserted;
wherein the movable lead of the second vacuum interrupter is inserted in the link mechanism case so as to allow communication between the inside of the link mechanism case and an inner side of the bellows of the second vacuum interrupter through a portion of the link case mechanism in which the movable lead of the second vacuum interrupter is inserted;
wherein the insulating operation rod is inserted through an inside of the insulating support tube and through a side portion of the ground tank;
wherein a rotation drive shaft is coupled to the insulating operation rod within the operation room;
wherein one end portion of the rotation drive shaft is exposed outside from the operation room through a rotational seal;
wherein the inner side of the bellows of the first vacuum interrupter, the inner side of the bellows of the second vacuum interrupter, the inside of the link mechanism case and the inside of the insulating support tube communicate with one another to define a communication space;
wherein the communication space is hermetically isolated from a space inside the ground tank and outside the link mechanism case and the insulating support tube;
wherein the space communicating with the inner side of the bellows of the first vacuum interrupter and the inner side of the bellows of the second vacuum interrupter is filled with insulating gas of 0.3 MPa or lower; and
wherein the space inside the ground tank and outside the link mechanism case and the insulating support tube is filled with insulating gas of higher pressure than that of the insulating gas in the space communicating with the inner side of the bellows of the first vacuum interrupter and the inner side of the bellows of the second vacuum interrupter.

5. A vacuum circuit breaker, comprising:
first and second vacuum interrupters each having: a vacuum vessel with an insulating tube and a metallic flange; fixed and movable electrodes placed in the vacuum vessel; a movable lead supporting the movable electrode such that the movable electrode can be brought into contact with or separated from the fixed electrode; and a bellows disposed on a part of the movable lead inserted within the vacuum vessel;
a ground tank that accommodates the first vacuum interrupter and the second vacuum interrupter;
a link mechanism arranged in the ground tank so as to move the movable lead of the first vacuum interrupter and the movable lead of the second vacuum interrupter in an axial direction;
a link mechanism case that houses the link mechanism;
an insulating support tube disposed on an inner circumferential surface of the ground tank and supporting the link mechanism case; and
an insulating operation rod coupled to the link mechanism so as to cause operation of the link mechanism,
wherein the movable lead of the first vacuum interrupter is inserted in the link mechanism case so as to allow communication between an inside of the link mechanism case and an inner side of the bellows of the first vacuum interrupter through a portion of the link case mechanism in which the movable lead of the first vacuum interrupter is inserted;
wherein the movable lead of the second vacuum interrupter is inserted in the link mechanism case so as to allow communication between the inside of the link mechanism case and an inner side of the bellows of the second vacuum interrupter through a portion of the link case mechanism in which the movable lead of the second vacuum interrupter is inserted;
wherein the insulating operation rod is inserted through an inside of the insulating support tube and through a side portion of the ground tank;
wherein a linear seal is arranged in the portion of the ground tank through which the insulating operation rod is inserted;
wherein the inner side of the bellows of the first vacuum interrupter, the inner side of the bellows of the second vacuum interrupter, the inside of the link mechanism case and the inside of the insulating support tube communicate with one another to define a communication space;
wherein the communication space is hermetically isolated from a space inside the ground tank and outside the link mechanism case and the insulating support tube;
wherein the space communicating with the inner side of the bellows of the first vacuum interrupter and the inner side of the bellows of the second vacuum interrupter is filled with insulating gas of 0.3 MPa or lower; and
wherein the space inside the ground tank and outside the link mechanism case and the insulating support tube is filled with insulating gas of higher pressure than that of the insulating gas in the space communicating with the inner side of the bellows of the first vacuum interrupter and the inner side of the bellows of the second vacuum interrupter.
